(19) United States
(12) Patent Application Publication
(10) Pub. No.: US 2026/0242528 A1
(43) Pub. Date: Aug. 20, 2026

(54) PREPOLYMER COMPOSITION, POLYURETHANE RESIN, ELASTIC MOLDED ARTICLE, AND METHOD FOR PRODUCING PREPOLYMER COMPOSITION

(71) Applicant: MITSUI CHEMICALS, INC., Tokyo (JP)

(72) Inventor: Kazuhiro MAEKAWA, Sodegaura-shi, Chiba (JP)

(21) Appl. No.: 19/162,221

(22) PCT Filed: Feb. 29, 2024
(86) PCT No.: PCT/JP2024/007648

§ 371 Date: Sep. 4, 2025

(30) Foreign Application Priority Data
Mar. 7, 2023 (JP) 2023-034426

(51) Int. Cl. C08G 18/12; C08G 18/20; C08G 18/32; C08G 18/48; C08G 18/65

(52) U.S. Cl. CPC C08G 18/12; C08G 18/3206; C08G 18/4854; C08G 18/6511; C08G 18/2063; C08G 2150/00; C08G 2170/00

(57) ABSTRACT

A prepolymer composition of the present invention includes an isocyanate group-terminated prepolymer. The isocyanate group-terminated prepolymer contains a reaction product of a polyisocyanate component and a polyol component. The polyisocyanate component contains MDI. The polyol component contains a high molecular weight polyol and a low molecular weight polyol. The high molecular weight polyol contains a high molecular weight polyether polyol having Mn of above 700 and below 1300. The low molecular weight polyol contains a low molecular weight polyether polyol having Mn of above 150 and below 350. The NCO concentration is 6 to 8% by mass. A content ratio of the low molecular weight polyol is above 0.05 mol/kg and below 0.40 mol/kg with respect to the total amount of the polyisocyanate component, the high molecular weight polyol, and the low molecular weight polyol.

### TECHNICAL FIELD

The present invention relates to a prepolymer composition, a polyurethane resin, an elastic molded article, and a method for producing a prepolymer composition.

### BACKGROUND ART

The polyurethane resin has, for example, a soft segment formed by reaction of a polyisocyanate and a high molecular weight polyol and a hard segment formed by reaction of a polyisocyanate and a chain extender.

More specifically, the polyurethane resin obtained by the following method is known. In other words, first, 4,4′-diphenylmethane diisocyanate and polytetramethylene ether glycol (Mn1000) are reacted at 80° C., thereby obtaining an isocyanate group-terminated prepolymer having the isocyanate group concentration of 5.6%. Next, the isocyanate group-terminated prepolymer and 1,4-butylene glycol are reacted at 80° C., thereby obtaining the polyurethane resin (ref: for example, Patent Document 1 (Example 6)).

### CITATION LIST

### Patent Document

Patent Document 1: Japanese Unexamined Patent Publication No. H11-310621

### SUMMARY OF THE INVENTION

### Problem to be Solved by the Invention

On the other hand, the polyurethane resin may be required to have excellent appearance and excellent mechanical properties in accordance with its use.

The present invention includes a prepolymer composition capable of producing a polyurethane resin having excellent appearance and excellent mechanical properties, a polyurethane resin and an elastic molded article obtained from the prepolymer composition, and a method for producing the prepolymer composition.

### Means for Solving the Problem

The present invention [1] includes a prepolymer composition containing an isocyanate group-terminated prepolymer, wherein the isocyanate group-terminated prepolymer contains a reaction product of a polyisocyanate component and a polyol component; the polyisocyanate component contains a diphenylmethane diisocyanate; the polyol component contains a high molecular weight polyol and a low molecular weight polyol; the high molecular weight polyol contains a high molecular weight polyether polyol having a number average molecular weight of above 700 and below 1300; the low molecular weight polyol contains a low molecular weight polyether polyol having the number average molecular weight of above 150 and below 350; the isocyanate group concentration of the prepolymer composition is 6.0% by mass or more and 8.0% by mass or less; and a content ratio of the low molecular weight polyol is above 0.05 mol/kg and below 0.40 mol/kg with respect to the total amount of the polyisocyanate component, the high molecular weight polyol, and the low molecular weight polyol.

The present invention [2] includes a polyurethane resin containing a reaction product of a prepolymer composition and a chain extender, wherein the prepolymer composition contains an isocyanate group-terminated prepolymer; the isocyanate group-terminated prepolymer contains a reaction product of a polyisocyanate component and a polyol component; the polyisocyanate component contains a diphenylmethane diisocyanate; the polyol component contains a high molecular weight polyol and a low molecular weight polyol; the high molecular weight polyol contains a high molecular weight polyether polyol having a number average molecular weight of above 700 and below 1300; the low molecular weight polyol contains a low molecular weight polyether polyol having the number average molecular weight of above 150 and below 350; the isocyanate group concentration of the prepolymer composition is 6.0% by mass or more and 8.0% by mass or less; and a content ratio of the low molecular weight polyol is above 0.05 mol/kg and below 0.40 mol/kg with respect to the total amount of the polyisocyanate component, the high molecular weight polyol, and the low molecular weight polyol.

The present invention [3] includes an elastic molded article including the polyurethane resin described in the above-described [2].

The present invention [4] includes a method for producing a prepolymer composition; the prepolymer composition containing an isocyanate group-terminated prepolymer, including a step of preparing a polyisocyanate component and a polyol component and a step of reacting the polyisocyanate component with the polyol component to synthesize the isocyanate group-terminated prepolymer, wherein the polyisocyanate component contains a diphenylmethane diisocyanate; the polyol component contains a high molecular weight polyol and a low molecular weight polyol; the high molecular weight polyol contains a high molecular weight polyether polyol having a number average molecular weight of above 700 and below 1300; the low molecular weight polyol contains a low molecular weight polyether polyol having the number average molecular weight of above 150 and below 350; the isocyanate group concentration of the prepolymer composition is 6.0% by mass or more and 8.0% by mass or less; and a content ratio of the low molecular weight polyol is above 0.05 mol/kg and below 0.40 mol/kg with respect to the total amount of the polyisocyanate component, the high molecular weight polyol, and the low molecular weight polyol.

### Effect of the Invention

In the prepolymer composition of the present invention, the high molecular weight polyether polyol having the number average molecular weight within a predetermined range and the low molecular weight polyether polyol having the number average molecular weight within the predetermined range are used as a raw material. In addition, in the prepolymer composition of the present invention, the isocyanate group concentration is adjusted within the predetermined range. Further, in the prepolymer composition of the present invention, the content ratio of the low molecular weight polyol is adjusted within the predetermined range with respect to the total amount of the polyisocyanate component, the high molecular weight polyol, and the low molecular weight polyol. By combination of these conditions, the prepolymer composition of the present invention can produce the polyurethane resin having excellent appearance and excellent mechanical properties.

The polyurethane resin and the elastic molded article of the present invention are obtained by using the above-described prepolymer composition. Therefore, the polyurethane resin and the elastic molded article of the present invention have the excellent appearance and the excellent mechanical properties.

According to the method for producing a prepolymer composition of the present invention, it is possible to obtain the above-described prepolymer composition.

### DESCRIPTION OF EMBODIMENTS

### 1. Polyurethane Resin and Prepolymer Composition

A polyurethane resin contains a reaction product of a prepolymer composition (first component) and a chain extender (second component). The polyurethane resin is preferably made of the reaction product of the prepolymer composition (the first component) and the chain extender (the second component). In other words, the polyurethane resin is preferably a urethane cured product obtained by reaction and curing of the prepolymer composition and the chain extender.

The prepolymer composition (the first component) and the chain extender (the second component) are, for example, prepared as a resin kit. The prepolymer composition (the first component) and the chain extender (the second component) are mixed, and therefore, subjected to a urethanization reaction. In the following, each is described in detail.

### (1) Prepolymer Composition

The prepolymer composition (the first component) contains an isocyanate group-terminated prepolymer as an essential component. The isocyanate group-terminated prepolymer contains the reaction product of a polyisocyanate component and a polyol component. Preferably, the isocyanate group-terminated prepolymer is made of the reaction product of the polyisocyanate component and the polyol component.

### Polyisocyanate Component

The polyisocyanate component contains a diphenylmethane diisocyanate (MDI) as the essential component. Examples of the diphenylmethane diisocyanate include diphenylmethane diisocyanate monomers and diphenylmethane diisocyanate derivatives.

Examples of the diphenylmethane diisocyanate monomer include 4,4′-diphenylmethane diisocyanate, 2,4′-diphenylmethane diisocyanate, and 2,2′-diphenylmethane diisocyanate. These may be used alone or in combination of two or more.

An example of the diphenylmethane diisocyanate derivative includes a modified product obtained by modifying the above-described diphenylmethane diisocyanate monomer by a known method. Examples of the modified product include multimers, isocyanurate modified products, allophanate modified products, polyol modified products, biuret modified products, urea modified products, oxadiazinetrione modified products, and carbodiimide modified products. Further, an example of the diphenylmethane diisocyanate derivative includes polymethylene polyphenylene polyisocyanate (polymeric MDI). These may be used alone or in combination of two or more.

As the diphenylmethane diisocyanate, preferably, a diphenylmethane diisocyanate monomer is used, more preferably, a 4,4′-diphenylmethane diisocyanate is used.

The polyisocyanate component may contain another polyisocyanate as an optional component as long as it does not inhibit the excellent effect of the present invention. Examples of another polyisocyanate include other polyisocyanate monomers and other polyisocyanate derivatives.

Examples of the other polyisocyanate monomer include aromatic polyisocyanates excluding MDI, aliphatic polyisocyanates, and araliphatic polyisocyanates. Examples of the aromatic polyisocyanate excluding MDI include tolylene diisocyanate (TDI), toluidine diisocyanate (TODI), paraphenylene diisocyanate, and naphthalene diisocyanate (NDI). Examples of the aliphatic polyisocyanate include chain aliphatic polyisocyanates and alicyclic polyisocyanates. Examples of the chain aliphatic polyisocyanate include ethylene diisocyanate, trimethylene diisocyanate, tetramethylene diisocyanate, pentamethylene diisocyanate (PDI), and hexamethylene diisocyanate (HDI). Examples of the alicyclic polyisocyanate include isophorone diisocyanate (IPDI), norbornene diisocyanate (NBDI), methylenebis(cyclohexyl isocyanate) (H₁₂MDI), and bis(isocyanatomethyl)cyclohexane (H₆XDI). Examples of the araliphatic polyisocyanate include xylylene diisocyanate (XDI) and tetramethylxylylene diisocyanate (TMXDI). These other polyisocyanate monomers may be used alone or in combination of two or more.

An example of the other polyisocyanate derivative includes the above-described modified product obtained by modifying the other polyisocyanate monomer by a known method. These may be used alone or in combination of two or more.

These other polyisocyanates may be used alone or in combination of two or more. A content ratio of another polyisocyanate is, for example, 50% by mass or less, preferably 30% by mass or less, more preferably 20% by mass or less, further more preferably 10% by mass or less, particularly preferably 0% by mass with respect to the total amount of the polyisocyanate component.

In other words, the content ratio of the diphenylmethane diisocyanate is, for example, 50% by mass or more, preferably 70% by mass or more, more preferably 80% by mass or more, further more preferably 90% by mass or more, particularly preferably 100% by mass with respect to the total amount of the polyisocyanate component. The polyisocyanate component particularly preferably consists of the diphenylmethane diisocyanate.

### Polyol Component

The polyol component reacts with the polyisocyanate component, thereby synthesizing the isocyanate group-terminated prepolymer. The polyol component contains a high molecular weight polyol and a low molecular weight polyol. The polyol component preferably consists of the high molecular weight polyol and the low molecular weight polyol.

In the polyol component, the high molecular weight polyol is an organic compound having two or more hydroxyl groups in a molecule and having a relatively high molecular weight. A number average molecular weight of the high molecular weight polyol is, for example, above 400, preferably 500 or more. Further, the number average molecular weight of the high molecular weight polyol is, for example, 5000 or less, preferably 4000 or less, more preferably 3000 or less, further more preferably 2000 or less. The number average molecular weight can be determined as a molecular weight in terms of polystyrene by a known gel permeation chromatography method (hereinafter, the same applies).

An average functionality (average number of hydroxyl groups) of the high molecular weight polyol is, for example, 2 or more. Further, the average functionality (average number of hydroxyl groups) of the high molecular weight polyol is, for example, 6 or less, preferably 4 or less, more preferably 3 or less. The average functionality (average number of hydroxyl groups) of the high molecular weight polyol is particularly preferably 2.

The high molecular weight polyol contains a high molecular weight polyether polyol as the essential component. Examples of the high molecular weight polyether polyol include high molecular weight polytetramethylene ether polyols and high molecular weight polyoxy (C2 to C3) alkylene polyols.

Examples of the high molecular weight polytetramethylene ether polyol include crystalline high molecular weight polytetramethylene ether polyols. Examples of the crystalline high molecular weight polytetramethylene ether polyol include ring-opening polymers obtained by cationic polymerization of tetrahydrofuran. Further, examples of the high molecular weight polytetramethylene ether polyol include amorphous high molecular weight polytetramethylene ether polyols. The amorphous high molecular weight polytetramethylene ether polyol is, for example, obtained by copolymerization of the tetrahydrofuran with an alkyl-substituted tetrahydrofuran and/or dihydric alcohol. Crystalline shows a property of being solid at 25° C. In addition, amorphous shows a property of being liquid at 25° C. These may be used alone or in combination of two or more.

The high molecular weight polyoxyalkylene (C2 to C3) polyol is, for example, an addition polymer of an alkylene oxide using a known low molecular weight polyol or a known low molecular weight polyamine as an initiator. Examples of the alkylene oxide include alkylene oxides having 2 to 3 carbon atoms. More specifically, examples of the alkylene oxide include ethylene oxide (IUPAC name: oxirane), propylene oxide (1,2-propylene oxide (IUPAC name: methyloxirane)), and triethylene oxide (1,3-propylene oxide). These alkylene oxides may be used alone or in combination of two or more. As the alkylene oxide, preferably, ethylene oxide and propylene oxide are used. More specifically, examples of the high molecular weight polyoxyalkylene (C2 to C3) polyol include high molecular weight polyoxyethylene polyols, high molecular weight polyoxypropylene polyols, high molecular weight polyoxytriethylene polyols, and high molecular weight polyoxyethylene/polyoxypropylene polyols (random or block copolymers). These may be used alone or in combination of two or more.

From the viewpoint of appearance and mechanical properties, as the high molecular weight polyether polyol, preferably, a high molecular weight polytetramethylene ether polyol is used, more preferably, a high molecular weight polytetramethylene ether glycol (high molecular weight PTMEG) is used.

From the viewpoint of ease of production of the polyurethane resin, the number average molecular weight of the high molecular weight polyether polyol is above 700, preferably 800 or more, more preferably 900 or more. In addition, from the viewpoint of the appearance and the mechanical properties of the polyurethane resin, the number average molecular weight of the high molecular weight polyether polyol is below 1300, preferably 1200 or less, more preferably 1100 or less.

From the viewpoint of the appearance and the mechanical properties, the average functionality (average number of hydroxyl groups) of the high molecular weight polyether polyol is, for example, 2 or more. Further, the average functionality (average number of hydroxyl groups) of the high molecular weight polyether polyol is, for example, 6 or less, preferably 4 or less, more preferably 3 or less. The average functionality (average number of hydroxyl groups) of the high molecular weight polyether polyol is particularly preferably 2.

The high molecular weight polyol may contain another high molecular weight polyol as the optional component. Another high molecular weight polyol is the high molecular weight polyol (number average molecular weight of above 400) excluding the above-described high molecular weight polyether polyol. Examples of another high molecular weight polyol include high molecular weight polyester polyols, high molecular weight polycarbonate polyols, high molecular weight polyurethane polyols, high molecular weight epoxy polyols, high molecular weight vegetable oil polyols, high molecular weight polyolefin polyols, high molecular weight acrylic polyols, and high molecular weight vinyl monomer-modified polyols. These may be used alone or in combination of two or more.

The high molecular weight polyol preferably does not contain another high molecular weight polyol. In other words, the high molecular weight polyol preferably consists of the high molecular weight polyether polyol having the above-described number average molecular weight.

The content ratio of the high molecular weight polyol is, for example, 50 mol % or more, preferably 60 mol % or more, more preferably 70 mol % or more, further more preferably 80 mol % or more with respect to the total amount of the polyol component (total amount of the high molecular weight polyol and the low molecular weight polyol). Further, the content ratio of the high molecular weight polyol is, for example, 95 mol % or less, preferably 93 mol % or less, more preferably 90 mol % or less, further more preferably 88 mol % or less with respect to the total amount of the polyol component (total amount of the high molecular weight polyol and the low molecular weight polyol).

In the polyol component, the low molecular weight polyol is the organic compound having two or more hydroxyl groups in the molecule and having the relatively low molecular weight. In the polyol component, the number average molecular weight of the low molecular weight polyol is, for example, 400 or less, preferably below 350, more preferably 300 or less. In addition, in the polyol component, the number average molecular weight of the low molecular weight polyol is, for example, 50 or more, preferably 150 or more.

In the polyol component, the average functionality (average number of hydroxyl groups) of the low molecular weight polyol is, for example, 2 or more. In addition, in the polyol component, the average functionality (average number of hydroxyl groups) of the low molecular weight polyol is, for example, 6 or less, preferably 4 or less, more preferably 3 or less. In the polyol component, the average functionality (average number of hydroxyl groups) of the low molecular weight polyol is particularly preferably 2.

In the polyol component, the low molecular weight polyol contains the low molecular weight polyether polyol as the essential component. Examples of the low molecular weight polyether polyol include low molecular weight polytetramethylene ether polyols and low molecular weight polyoxy (C2 to C3)alkylene polyols.

Examples of the low molecular weight polytetramethylene ether polyol include crystalline low molecular weight polytetramethylene ether polyols. Examples of the crystalline low molecular weight polytetramethylene ether polyol include ring-opening polymers obtained by the cationic polymerization of the tetrahydrofuran. Further, examples of the low molecular weight polytetramethylene ether polyol include amorphous low molecular weight polytetramethylene ether polyols. The amorphous low molecular weight polytetramethylene ether polyol is, for example, obtained by the copolymerization of the tetrahydrofuran with the alkyl-substituted tetrahydrofuran and/or the dihydric alcohol. The crystalline shows the property of being solid at 25° C. In addition, the amorphous property shows the property of being liquid at 25° C. These may be used alone or in combination of two or more.

The low molecular weight polyoxyalkylene (C2 to C3) polyol is, for example, the addition polymer of the alkylene oxide using a known low molecular weight polyol or a known low molecular weight polyamine as the initiator. Examples of the alkylene oxide include alkylene oxides having 2 to 3 carbon atoms. More specifically, examples of the alkylene oxide include ethylene oxide (IUPAC name: oxirane), propylene oxide (1,2-propylene oxide (IUPAC name: methyloxirane)), and triethylene oxide (1,3-propylene oxide). These alkylene oxides may be used alone or in combination of two or more. As the alkylene oxide, preferably, ethylene oxide and propylene oxide are used. More specifically, examples of the low molecular weight polyoxyalkylene (C2 to C3) polyol include low molecular weight polyoxyethylene polyols, low molecular weight polyoxypropylene polyols, low molecular weight polyoxytriethylene polyols, and low molecular weight polyoxyethylene/polyoxypropylene polyols (random or block copolymers). These may be used alone or in combination of two or more.

From the viewpoint of the appearance and the mechanical properties, as the low molecular weight polyether polyol, preferably, a low molecular weight polytetramethylene ether polyol is used, more preferably, a low molecular weight polytetramethylene ether glycol (low molecular weight PTMEG) is used.

From the viewpoint of the ease of production of the polyurethane resin, the number average molecular weight of the low molecular weight polyether polyol is above 150, preferably 200 or more, more preferably 230 or more. In addition, from the viewpoint of the appearance and the mechanical properties of the polyurethane resin, the number average molecular weight of the low molecular weight polyether polyol is below 350, preferably 300 or less, more preferably 280 or less.

From the viewpoint of the appearance and the mechanical properties, the average functionality (average number of hydroxyl groups) of the low molecular weight polyether polyol is, for example, 2 or more. Further, the average functionality (average number of hydroxyl groups) of the low molecular weight polyether polyol is, for example, 6 or less, preferably 4 or less, more preferably 3 or less. The average functionality (average number of hydroxyl groups) of the low molecular weight polyether polyol is particularly preferably 2.

The low molecular weight polyol may contain another low molecular weight polyol as the optional component. Another low molecular weight polyol is the low molecular weight polyol (number average molecular weight of 400 or less) excluding the above-described low molecular weight polyether polyol. Examples of another low molecular weight polyol include dihydric alcohol to be described later, trihydric alcohol to be described later, and tetrahydric or more alcohol to be described later. These may be used alone or in combination of two or more.

The low molecular weight polyol preferably does not contain another low molecular weight polyol. In other words, the low molecular weight polyol preferably consists of the low molecular weight polyether polyol having the above-described number average molecular weight.

The content ratio of the low molecular weight polyol is, for example, 5 mol % or more, preferably 7 mol % or more, more preferably 10 mol % or more, further more preferably 12 mol % or more with respect to the total amount of the polyol component (total amount of the high molecular weight polyol and the low molecular weight polyol). Further, the content ratio of the low molecular weight polyol is, for example, 50 mol % or less, preferably 40 mol % or less, more preferably 30 mol % or less, further more preferably 20 mol % or less with respect to the total amount of the polyol component (total amount of the high molecular weight polyol and the low molecular weight polyol).

Further, the content ratio of the low molecular weight polyol is, for example, 1 part by mass or more, preferably 2 parts by mass or more, more preferably 3 parts by mass or more with respect to 100 parts by mass of the high molecular weight polyol. Further, the content ratio of the low molecular weight polyol is, for example, 20 parts by mass or less, preferably 15 parts by mass or less, more preferably 10 parts by mass or less with respect to 100 parts by mass of the high molecular weight polyol.

### Method for Producing Prepolymer Composition

The prepolymer composition is obtained as a reaction product solution, for example, by reacting the above-described polyisocyanate component with the above-described polyol component.

More specifically, the prepolymer composition is produced by the following method. In other words, for example, first, the above-described polyisocyanate component and the above-described polyol component are prepared (preparation step). Next, the above-described polyisocyanate component and the above-described polyol component are reacted at a predetermined ratio, thereby synthesizing the isocyanate group-terminated prepolymer (prepolymer synthesis step).

In the prepolymer synthesis step, an equivalent ratio R1 (NCO/OH) of isocyanate groups in the polyisocyanate component to hydroxyl groups in the polyol component is, for example, above 1.0, preferably 1.5 or more, more preferably 1.8 or more, further more preferably 2.0 or more. In addition, the equivalent ratio R1 (NCO/OH) of the isocyanate groups in the polyisocyanate component to the hydroxyl groups in the polyol component is, for example, 20 or less, preferably 10 or less, more preferably 5.0 or less, further more preferably 3.0 or less.

In addition, the content ratio of the high molecular weight polyol and the low molecular weight polyol in the polyol component is as described above.

In addition, in this method, from the viewpoint of the ease of production of the polyurethane resin, the appearance, and the mechanical properties, the content ratio of the low molecular weight polyol to the total amount of the polyisocyanate component, the high molecular weight polyol, and the low molecular weight polyol is adjusted.

More specifically, the content ratio of the low molecular weight polyol is, from the viewpoint of the appearance and the mechanical properties of the polyurethane resin, above 0.05 mol/kg, preferably 0.06 mol/kg or more, more preferably 0.08 mol/kg or more, further more preferably 0.10 mol/kg or more with respect to the total amount of the polyisocyanate component, the high molecular weight polyol, and the low molecular weight polyol.

In addition, the content ratio of the low molecular weight polyol is, from the viewpoint of the ease of production of the polyurethane resin, below 0.40 mol/kg, preferably 0.35 mol/kg or less, more preferably 0.30 mol/kg or less, further more preferably 0.20 mol/kg or less with respect to the total amount of the polyisocyanate component, the high molecular weight polyol, and the low molecular weight polyol.

In addition, the content ratio of the high molecular weight polyol is, from the viewpoint of the ease of production of the polyurethane resin, for example, 0.40 mol/kg or more, preferably 0.45 mol/kg or more, more preferably 0.50 mol/kg or more, further more preferably 0.55 mol/kg or more with respect to the total amount of the polyisocyanate component, the high molecular weight polyol, and the low molecular weight polyol.

In addition, the content ratio of the high molecular weight polyol is, from the viewpoint of the appearance and the mechanical properties of the polyurethane resin, for example, 0.80 mol/kg or less, preferably 0.70 mol/kg or less, more preferably 0.65 mol/kg or less, further more preferably 0.60 mol/kg or less with respect to the total amount of the polyisocyanate component, the high molecular weight polyol, and the low molecular weight polyol.

In addition, the content ratio of the polyisocyanate component is, from the viewpoint of the appearance and the mechanical properties of the polyurethane resin, for example, 1.30 mol/kg or more, preferably 1.35 mol/kg or more, more preferably 1.40 mol/kg or more, further more preferably 1.45 mol/kg or more with respect to the total amount of the polyisocyanate component, the high molecular weight polyol, and the low molecular weight polyol.

In addition, the content ratio of the polyisocyanate component is, from the viewpoint of the ease of production of the polyurethane resin, for example, 1.80 mol/kg or less, preferably 1.70 mol/kg or less, more preferably 1.65 mol/kg or less, further more preferably 1.60 mol/kg or less with respect to the total amount of the polyisocyanate component, the high molecular weight polyol, and the low molecular weight polyol.

In the prepolymer synthesis step, examples of a reaction method include bulk polymerization and solution polymerization. In the bulk polymerization, for example, the polyisocyanate component and the polyol component are reacted under a nitrogen stream. A reaction temperature is, for example, 50° C. or more. Further, a reaction temperature is, for example, 250° C. or less, preferably 200° C. or less. Further, reaction time is, for example, 0.5 hours or more, preferably 1 hour or more. Further, the reaction time is, for example, 15 hours or less. In the solution polymerization, the polyisocyanate component and the polyol component are reacted under the presence of a known organic solvent. The reaction temperature is, for example, 50° C. or more. Further, the reaction temperature is, for example, 120° C. or less, preferably 100° C. or less. Further, the reaction time is, for example, 0.5 hours or more, preferably 1 hour or more. Further, the reaction time is, for example, 15 hours or less.

Further, the reaction conditions in the prepolymer synthesis step are, for example, appropriately set so that the isocyanate group concentration of the prepolymer composition is adjusted within a range to be described later.

Then, in the prepolymer synthesis step, the prepolymer composition containing the isocyanate group-terminated prepolymer is obtained as the reaction product solution. More specifically, the prepolymer composition contains the isocyanate group-terminated prepolymer and, if necessary, may contain an unreacted polyisocyanate component.

The isocyanate group concentration of the prepolymer composition is 6.0% by mass or more, preferably 6.5% by mass or more, more preferably 6.8% by mass or more. Further, the isocyanate group concentration of the prepolymer composition is 8.0% by mass or less, preferably 7.5% by mass or less, more preferably 7.2% by mass or less. The isocyanate group concentration can be determined by a known measurement method. Examples of the measurement method include a titration method with di-n-butylamine and an FT-IR spectrometry (hereinafter, the same applies).

A method for adjusting the isocyanate group concentration of the prepolymer composition is not particularly limited. For example, in the prepolymer synthesis step, the reaction is continued until the isocyanate group concentration of the reaction product solution (prepolymer composition) reaches the above-described range (range of the isocyanate group concentration of the prepolymer composition). Then, when the isocyanate group concentration of the reaction product solution (prepolymer composition) reaches the above-described range, the reaction is stopped.

Further, for example, it is possible to refine the reaction product solution in the prepolymer synthesis step by a known method, and to adjust the isocyanate group concentration within the above-described range. Examples of a refining method include distillation and extraction.

Further, for example, it is also possible to add the polyisocyanate component (for example, diphenylmethane diisocyanate) to the reaction product solution in the prepolymer synthesis step, and to adjust the isocyanate group concentration within the above-described range.

Preferably, the reaction is continued until the isocyanate group concentration of the reaction product solution (prepolymer composition) reaches the above-described range (range of the isocyanate group concentration of the prepolymer composition). Then, when the isocyanate group concentration of the reaction product solution (prepolymer composition) reaches the above-described range, the reaction is stopped.

The prepolymer composition may contain an additive as the optional component. Examples of the additive include urethanization catalysts, catalyst activity modifiers, antioxidants, heat-resistant stabilizers, light-resistant stabilizers, ultraviolet absorbers, anti-blocking agents, mold release agents, pigments, dyes, lubricants, fillers, hydrolysis inhibitors, rust inhibitors, and bluing agents. An addition amount and addition timing of the additive are appropriately set in accordance with its purpose and use.

### Function and Effect

In the above-described prepolymer composition, the high molecular weight polyether polyol having the number average molecular weight within a predetermined range and the low molecular weight polyether polyol having the number average molecular weight within the predetermined range are used as the raw material. In addition, in the above-described prepolymer composition, the isocyanate group concentration is adjusted within the predetermined range. Further, in the above-described prepolymer composition, the content ratio of the low molecular weight polyol is adjusted within the predetermined range with respect to the total amount of the polyisocyanate component, the high molecular weight polyol, and the low molecular weight polyol. By the combination of these conditions, the above-described prepolymer composition can produce the polyurethane resin having the excellent appearance and the excellent mechanical properties.

Further, according to the above-described method for producing a prepolymer composition, it is possible to obtain the above-described prepolymer composition.

### (2) Chain Extender

The chain extender is a curing agent for the prepolymer composition. The chain extender is a compound having two or more active hydrogen groups in its molecule. Examples of the active hydrogen group include hydroxyl groups and amino groups. Examples of the chain extender include low molecular weight polyols and low molecular weight polyamines. As the chain extender, preferably, a low molecular weight polyol is used. By using the low molecular weight polyol, the polyurethane resin having excellent mechanical strength is obtained.

In the chain extender, the low molecular weight polyol is an organic compound having two or more hydroxyl groups in its molecule and having the relatively low molecular weight. In the chain extender, the number average molecular weight of the low molecular weight polyol is, for example, 400 or less, preferably 300 or less. In addition, in the chain extender, the number average molecular weight of the low molecular weight polyol is, for example, 50 or more.

In the chain extender, the average functionality (average number of hydroxyl groups) of the low molecular weight polyol is, for example, 2 or more. In addition, in the chain extender, the average functionality (average number of hydroxyl groups) of the low molecular weight polyol is, for example, 6 or less, preferably 4 or less, more preferably 3 or less. In the chain extender, the average functionality (average number of hydroxyl groups) of the low molecular weight polyol is particularly preferably 2.

In the chain extender, examples of the low molecular weight polyol include dihydric alcohol, trihydric alcohol, and tetrahydric or more alcohol. Examples of the dihydric alcohol include ethylene glycol, 1,2-propanediol, 1,3-propanediol, 1,2-butanediol, 1,3-butanediol, 1,4-butanediol, 1,5-pentanediol, 1,6-hexanediol, neopentyl glycol, diethylene glycol, triethylene glycol, and dipropylene glycol. Examples of the trihydric alcohol include glycerin and trimethylolpropane. Examples of the tetrahydric or more alcohol include pentaerythritol and diglycerin. These may be used alone or in combination of two or more.

As the low molecular weight polyol, preferably, dihydric alcohol and trihydric alcohol may be used, more preferably, dihydric alcohol is used, further more preferably, 1,4-butanediol is used. That is, the low molecular weight polyol preferably contains 1,4-butanediol, and more preferably consists of 1,4-butanediol.

The chain extender may contain the additive as the optional component. That is, the chain extender may be a chain extender composition. Examples of the additive include urethanization catalysts, catalyst activity modifiers, antioxidants, heat-resistant stabilizers, light-resistant stabilizers, ultraviolet absorbers, anti-blocking agents, mold release agents, pigments, dyes, lubricants, fillers, hydrolysis inhibitors, rust inhibitors, and bluing agents. The addition amount and the addition timing of the additive are appropriately set in accordance with its purpose and use.

### (3) Polyurethane Resin

As described above, the polyurethane resin contains a reaction product of the prepolymer composition (the first component) and the chain extender (the second component). The polyurethane resin is preferably made of the reaction product of the prepolymer composition (the first component) and the chain extender (the second component).

The polyurethane resin is, for example, produced by the following method. That is, first, the prepolymer composition is produced by the above-described method (the preparation step and the prepolymer synthesis step). Next, the prepolymer composition is reacted with the above-described chain extender, so that the isocyanate group-terminated prepolymer is chain-extended (chain extension step).

In the chain extension step, an equivalent ratio R2 (NCO/active hydrogen group) of the isocyanate groups in the prepolymer composition to the active hydrogen groups in the chain extender is, for example, 0.90 or more, preferably 1.00 or more, more preferably 1.02 or more. In addition, the equivalent ratio R2 (NCO/active hydrogen group) of the isocyanate groups in the prepolymer composition to the active hydrogen groups in the chain extender is, for example, 1.33 or less, preferably 1.25 or less.

In the chain extension step, examples of the reaction method include the above-described bulk polymerization and the above-described solution polymerization. In the bulk polymerization, the reaction temperature is, for example, 50° C. or more, preferably 100° C. or more. Further, the reaction temperature is, for example, 250° C. or less, preferably 200° C. or less, more preferably 180° C. or less, further more preferably 150° C. or less. Further, the reaction time is, for example, 0.5 hours or more, preferably 1 hour or more. In addition, the reaction time is, for example, 24 hours or less, preferably 20 hours or less, more preferably 18 hours or less. In the solution polymerization, the reaction temperature is, for example, 50° C. or more. Further, the reaction temperature is, for example, 120° C. or less, preferably 150° C. or less. Further, the reaction time is, for example, 0.5 hours or more, preferably 1 hour or more. Further, the reaction time is, for example, 24 hours or less.

Also, if necessary, the known urethanization catalyst is added. Examples of the urethanization catalyst include amine catalysts, organic metal catalysts, and potassium salt catalysts. As the urethanization catalyst, preferably, an amine catalyst is used. The addition ratio of the urethanization catalyst is appropriately set in accordance with its purpose and use. For example, the addition ratio of the urethanization catalyst is, for example, above 0 ppm, and for example, 1000 ppm or less, preferably 500 ppm or less with respect to the total amount of the prepolymer composition, the chain extender, and the urethanization catalyst. In addition, the timing of the addition of the urethanization catalyst is appropriately set in accordance with its purpose and use. For example, the urethanization catalyst may be added to the prepolymer composition and/or the chain extender, may be added at the time of blending of the prepolymer composition and the chain extender, and may be added to the mixture of the prepolymer composition and the chain extender.

Then, in the chain extension step, the polyurethane resin containing the reaction product of the prepolymer composition and the chain extender is obtained.

The polyurethane resin may also contain a known additive if necessary. In other words, the polyurethane resin may be also a polyurethane resin composition. Examples of the additive include urethanization catalysts, catalyst activity modifiers, antioxidants, heat-resistant stabilizers, light-resistant stabilizers, ultraviolet absorbers, anti-blocking agents, mold release agents, pigments, dyes, lubricants, fillers, hydrolysis inhibitors, rust inhibitors, and bluing agents. The addition amount and the addition timing of the additive are appropriately set in accordance with its purpose and use.

Further, the polyurethane resin may be subjected to a heat treatment, if necessary. A heat treatment temperature is, for example, 50° C. or more, preferably 80° C. or more. Further, the heat treatment temperature is, for example, 200° C. or less, preferably 150° C. or less. Further, heat treatment time is, for example, 30 minutes or more, preferably 1 hour or more. Further, the heat treatment time is, for example, 30 hours or less, preferably 20 hours or less.

Further, the polyurethane resin may be aged. An aging temperature is, for example, 10° C. or more, preferably 20° C. or more. Further, the aging temperature is, for example, 50° C. or less, preferably 40° C. or less. Further, aging time is, for example, 1 hour or more, preferably 10 hours or more. Further, the aging time is, for example, 50 days or less, preferably 30 days or less.

### Function and Effect

Since the above-described polyurethane resin is obtained by using the above-described prepolymer composition, it has the excellent appearance and the excellent mechanical properties.

Therefore, the polyurethane resin and the prepolymer composition described above are preferably used in various industrial fields requiring the appearance and the mechanical properties. Examples of the industrial field include elastic molded articles, paints, coating agents, and adhesives. Preferably, an elastic molded article is used.

### 2. Elastic Molded Article

Examples of the elastic molded article include polyurethane elastomers. Examples of the polyurethane elastomer include TPU (thermoplastic polyurethane resins) and TSU (thermosetting polyurethane resins). As the elastic molded article, preferably, TSU (thermosetting polyurethane resin) is used.

The elastic molded article is obtained by molding the polyurethane resin by a known molding method. Examples of the molding method include cast molding, heat compression molding, injection molding, extrusion molding, and spinning molding. Further, examples of the shape after the molding include plate shapes, fiber shapes, strand shapes, film shapes, sheet shapes, pipe shapes, bottle shapes, hollow shapes, box shapes, and button shapes.

The elastic molded article is preferably obtained by the cast molding. Therefore, the elastic molded article is preferably a cast polyurethane elastomer. The cast polyurethane elastomer is a molded article (cast molded article) obtained by the cast molding and an article having a predetermined shape in accordance with its purpose and use alone, and is distinguished from the coating agent coated onto an object to be coated.

More specifically, in the cast molding, preferably, the prepolymer composition and the chain extender are mixed, thereby preparing the polyurethane resin composition. Then, the polyurethane resin composition is defoamed, if necessary, and supplied into a preheated mold. Thus, the polyurethane resin composition is heated in the mold to be cured. Thus, the elastic molded article (polyurethane elastomer) which is molded into a desired shape is obtained.

In such a case, from the viewpoint of the appearance of the elastic molded article (polyurethane elastomer), preferably, the polyurethane resin composition is supplied to the mold having a relatively low temperature. Thereafter, the mold is heated, and the polyurethane resin composition is held in the mold having a predetermined temperature (curing temperature) for the predetermined time. Thus, the polyurethane resin composition is reacted and cured.

A mold temperature (initial temperature) at the time of supplying the polyurethane resin composition is, for example, 50° C. or more, preferably 60° C. or more. In addition, from the viewpoint of the appearance of the elastic molded article (polyurethane elastomer), the mold temperature (initial temperature) at the time of supplying the polyurethane resin composition is, for example, 200° C. or less, preferably 150° C. or less, more preferably 120° C. or less, further more preferably 100° C. or less, particularly preferably 80° C. or less.

The mold temperature (curing temperature) at the time of the reaction of the polyurethane resin composition is, for example, 80° C. or more, preferably 100° C. or more. Further, the reaction temperature is, for example, 250° C. or less, preferably 200° C. or less, more preferably 180° C. or less, further more preferably 150° C. or less.

In addition, holding time (reaction time) of the polyurethane resin composition in the mold is, for example, 0.5 hours or more, preferably 1 hour or more. In addition, the holding time (reaction time) of the polyurethane resin composition in the mold is, for example, 24 hours or less, preferably 20 hours or less, more preferably 18 hours or less.

Since such an elastic molded article is obtained by using the above-described prepolymer composition, it has the excellent appearance and the excellent mechanical properties.

Therefore, the elastic molded article is preferably used in various uses. Specifically, examples of the use of the elastic molded article include transparent hard plastics, waterproof materials, potting agents, ink, binders, films, sheets, bands, belts, shoe press belts, tubes, blades, speakers, sensors, outsoles, threads, fibers, non-woven fabrics, cosmetics, shoe products, heat insulation materials, sealing materials, tape materials, encapsulated materials, solar power generation members, robotic members, android members, wearable members, clothing, sanitary products, cosmetic supplies, furniture, food packaging members, sporting goods, leisure goods, medical products, nursing care products, housing members, acoustic members, lighting members, vibration proofing members, soundproofing members, daily necessities, miscellaneous goods, cushions, bedding materials, stress-absorbing materials, stress relievers, automobile interior materials, automobile exterior materials, railroad materials, aircraft parts, optical members, OA equipment members, miscellaneous goods surface-protection materials, semiconductor sealing materials, self-healing materials, healthcare equipment, eyeglasses lenses, toys, packings, cable sheaths, wire harnesses, telecommunication cables, automotive wirings, computer wirings, industrial goods, impact absorbers, semiconductor goods, bridge bearings, and polishing pads.

### EXAMPLES

Next, the present invention is further described based on Examples and Comparative Examples below. The present invention is however not limited by these Examples and Comparative Examples. All designations of “part” or “parts” and “%” mean part or parts by mass and % by mass, respectively, unless otherwise particularly specified. The specific numerical values in mixing ratio (content ratio), property value, and parameter used in the following description can be replaced with upper limit values (numerical values defined as “or less” or “below”) or lower limit values (numerical values defined as “or more” or “above”) of corresponding numerical values in mixing ratio (content ratio), property value, and parameter described in the above-described “DESCRIPTION OF EMBODIMENTS”.

### 1. Raw Materials

### (1) Polyisocyanate Component

MDI: 4,4′-diphenylmethane diisocyanate, trade name: COSMONATE PH, manufactured by Mitsui Chemicals, Inc.

### (2) Polyol Component

### High Molecular Weight Polyether Polyol

PTMEG700: polytetramethylene ether glycol, number average molecular weight (Mn) of 700
PTMEG800: polytetramethylene ether glycol, number average molecular weight (Mn) of 800
PTMEG1000: polytetramethylene ether glycol, number average molecular weight (Mn) of 1000
PTMEG1200: polytetramethylene ether glycol, number average molecular weight (Mn) of 1200
PTMEG1300: polytetramethylene ether glycol, number average molecular weight (Mn) of 1300

### Low Molecular Weight Polyether Polyol

PTMEG150: polytetramethylene ether glycol, number average molecular weight (Mn) of 150
PTMEG250: polytetramethylene ether glycol, number average molecular weight (Mn) of
PTMEG350: polytetramethylene ether glycol, number average molecular weight (Mn) of 350

### (3) Chain Extender

1,4-BD: 1,4-butanediol

### (4) Urethanization Catalyst

DABCO 33LV: amine catalyst, manufactured by Evonik Industries AG

### 2. Prepolymer Composition and Polyurethane Resin

### Examples 1 to 14 and Comparative Examples 1 to 12

### (1) Preparation Step

The polyisocyanate component and the polyol component (the high molecular weight polyol and the low molecular weight polyol) were prepared in the formulations described in Tables 1 to 7.

Each of the content ratio (mol/kg) of the polyisocyanate component, the content ratio (mol/kg) of the high molecular weight polyol, and the content ratio (mol/kg) of the low molecular weight polyol with respect to the total amount of the polyisocyanate component, the high molecular weight polyol, and the low molecular weight polyol is shown in Tables 1 to 7.

### (2) Prepolymer Synthesis Step

The polyisocyanate component and the polyol component were reacted at 80° C. under a nitrogen atmosphere in the formulations and the conditions described in Tables 1 to 7. In Tables 1 to 7, the equivalent ratio R1 of the prepolymer synthesis step shows the equivalent ratio R1 (NCO/OH) of the isocyanate groups in the polyisocyanate component to the hydroxyl groups in the polyol component.

The isocyanate group concentration of the reaction product solution was measured by an n-dibutylamine method in conformity with JIS K-1556 (2006) by using a potentiometric titrator. Then, when the isocyanate group concentration of the reaction product solution reached the value in the table, the reaction was stopped. Thus, the prepolymer composition containing the isocyanate group-terminated prepolymer was obtained.

### (3) Chain Extension Step

The prepolymer composition and the chain extender (with the urethanization catalysts) were prepared in the formulations described in Tables 1 to 7. The prepolymer composition and the chain extender were heated at 60° C. In Tables 1 to 7, the equivalent ratio R2 in the chain extension step shows the equivalent ratio R2 (NCO/active hydrogen group) of the isocyanate groups in the prepolymer composition to the active hydrogen groups in the chain extender.

Then, the prepolymer composition and the chain extender (with the urethanization catalyst) were mixed, thereby obtaining the polyurethane resin composition. The polyurethane resin composition was vacuum-defoamed.

The temperature of the mold (2-mm thickness, sheet-shaped) was adjusted to the initial temperature described in Tables 1 to 7. Then, the polyurethane resin composition was poured into the mold. Then, the temperature of the mold was adjusted to the curing temperature described in Tables 1 to 7, and the polyurethane resin composition was held in the mold. After the holding time described in Tables 1 to 7 passed, the contents of the mold were demolded. Thus, the polyurethane resin (polyurethane elastomer, elastic molded article) was obtained.

Next, the polyurethane resin was heat treated in an oven at 110° C. for 15 hours. Thereafter, the polyurethane resin was aged under constant temperature and humidity conditions of room temperature of 23° C. and relative humidity of 55% for seven days.

### 3. Evaluation

### (1) A Hardness

Shore A hardness of the polyurethane resin was measured in conformity with JIS K 7312 (1996).

### (2) Tensile Properties

Tensile properties of the polyurethane resin were measured in conformity with JIS K 7312 (1996) with a universal tensile testing machine (205N, manufactured by INTESCO co., ltd.). In other words, the polyurethane resin was cut, thereby obtaining a No. 3 dumbbell test piece. Then, 100% modulus (MPa), 300% modulus (MPa), tensile strength (MPa), and elongation at break (%) were measured under the conditions of the tensile rate of 500 mm/min.

### (3) Abrasion Resistance (Taper Abrasion)

Abrasion resistance of the polyurethane resin was evaluated by the following method. In other words, the surface of the polyurethane resin was abraded under the conditions of a load of 1 kg, a rotation rate of 60 rpm, and 1000 rotations by using a taper abrasion testing machine (manufactured by Toyo Seiki Seisaku-Sho, Ltd.) and an abrasion ring of H-22. Then, a mass difference (mg) of the polyurethane resin before and after the test was measured. The less the mass difference (mg), the more excellent the abrasion resistance.

### (4) Appearance

Small pieces of 100 cm² were cut out from a 2-mm thickness sheet. The appearance of the small piece was evaluated on the following five-stage scale of 5 to 1.
Evaluation 5: there are below 3 white dots of 0.1 mm² or more.
Evaluation 4: there are more than 3 white dots of 0.1 mm² or more.
Evaluation 3: there are more than 10 white dots of 0.1 mm² or more.
Evaluation 2: there are more than 20 white dots of 0.1 mm² or more.
Evaluation 1: there are more than 50 white dots of 0.1 mm² or more.

TABLE 1

| | | | Ex. 1 | Ex. 2 | Ex. 3 | Ex. 4 |
|---|---|---|---|---|---|---|
| Prepolymer | Polyisocyanate | Kind | MDI | MDI | MDI | MDI |
| Synthesis Step | Component | | | | | |
| | High Molecular | Kind | PTMEG | PTMEG | PTMEG | PTMEG |
| | Weight Polyol | Number Average | 1000 | 1000 | 1000 | 1000 |
| | | Molecular Weight | | | | |
| | Low Molecular | Kind | PTMEG | PTMEG | PTMEG | PTMEG |
| | Weight Polyol | Number Average | 250 | 250 | 250 | 250 |
| | | Molecular Weight | | | | |
| | Equivalent Ratio R1 | (NCO/OH) | 2.2 | 2.2 | 2.2 | 2.2 |
| | Content Ratio of | (mol/kg) | 1.50/0.59/0.10 | 1.50/0.59/0.10 | 1.50/0.59/0.10 | 1.50/0.59/0.10 |
| | Each Component to | | | | | |
| | Total Amount of | | | | | |
| | Polyisocyanate | | | | | |
| | Component, High | | | | | |
| | Molecular Weight | | | | | |
| | Polyol, and Low | | | | | |
| | Molecular Weight | | | | | |
| | Polyol | | | | | |
| | [Polyisocyanate | | | | | |
| | Component/High | | | | | |
| | Molecular Weight | | | | | |
| | Polyol/Low | | | | | |
| | Molecular Weight | | | | | |
| | Polyol] | | | | | |
| | Isocyanate Group | (% by mass) | 7.0 | 7.0 | 7.0 | 7.0 |
| | Concentration | | | | | |
| Chain Extension | Equivalent Ratio R2 | (NCO/OH) | 1.05 | 1.05 | 1.05 | 1.05 |
| Step | Urethanization | Kind | — | DABCO 33LV | DABCO 33LV | DABCO 33LV |
| | Catalyst | Mixing Amount | 0 | 500 | 500 | 500 |
| | Chain Extender | Kind | 1,4-BD | 1,4-BD | 1,4-BD | 1,4-BD |
| Reaction | Initial Temperaturc | (° C.) | 110 | 110 | 80 | 60 |
| Conditions | Curing Temperature | (° C.) | 110 | 110 | 110 | 110 |
| | Holding Time | (hour) | 16 | 16 | 16 | 16 |
| Evaluation | A Hardness | — | 90 | 90 | 90 | 90 |
| | 100% Modulus | (MPa) | 9 | 9 | 9 | 9 |
| | 300% Modulus | (MPa) | 17 | 17 | 17 | 17 |
| | Tensile Strength | (MPa) | 41 | 41 | 41 | 41 |
| | Elongation at Break | (%) | 470 | 470 | 470 | 470 |
| | Taper Abrasion | (mg) | 20 | 20 | 20 | 20 |
| | Appearance | (%) | 4 | 4 | 5 | 5 |

TABLE 2

| | | | Ex. 5 | Ex. 6 | Ex. 7 | Ex. 8 |
|---|---|---|---|---|---|---|
| Prepolymer | Polyisocyanate | Kind | MDI | MDI | MDI | MDI |
| Synthesis Step | Component | | | | | |
| | High Molecular | Kind | PTMEG | PTMEG | PTMEG | PTMEG |
| | Weight Polyol | Number Average | 1000 | 1000 | 1000 | 1000 |
| | | Molecular Weight | | | | |
| | Low Molecular | Kind | PTMEG | PTMEG | PTMEG | PTMEG |
| | Weight Polyol | Number Average | 250 | 250 | 250 | 250 |
| | | Molecular Weight | | | | |
| | Equivalent Ratio R1 | (NCO/OH) | 2.0 | 2.0 | 2.0 | 2.0 |
| | Content Ratio of | (mol/kg) | 1.63/0.51/0.30 | 1.63/0.51/0.30 | 1.63/0.51/0.30 | 1.63/0.51/0.30 |
| | Each Component to | | | | | |
| | Total Amount of | | | | | |
| | Polyisocyanatc | | | | | |
| | Component, High | | | | | |
| | Molecular Weight | | | | | |
| | Polyol, and Low | | | | | |
| | Molecular Weight | | | | | |
| | Polyol | | | | | |
| | [Polyisocyanate | | | | | |
| | Component/High | | | | | |
| | Molecular Weight | | | | | |
| | Polyol/Low | | | | | |
| | Molecular Weight | | | | | |
| | Polyol] | | | | | |
| | Isocyanate Group | (% by mass) | 7.0 | 7.0 | 7.0 | 7.0 |
| | Concentration | | | | | |
| Chain Extension | Equivalent Ratio R2 | (NCO/OH) | 1.05 | 1.05 | 1.05 | 1.05 |
| Step | Urethanization | Kind | — | DABCO 33LV | DABCO 33LV | DABCO 33LV |
| | Catalyst | Mixing Amount | 0 | 500 | 500 | 500 |
| | Chain Extender | Kind | 1,4-BD | 1,4-BD | 1,4-BD | 1,4-BD |
| Reaction | Initial Temperature | (° C.) | 110 | 110 | 80 | 60 |
| Conditions | Curing Temperature | (° C.) | 110 | 110 | 110 | 110 |
| | Holding Time | (hour) | 16 | 16 | 16 | 16 |
| Evaluation | A Hardness | — | 95 | 95 | 95 | 95 |
| | 100% Modulus | (MPa) | 10 | 10 | 10 | 10 |
| | 300% Modulus | (MPa) | 21 | 21 | 21 | 21 |
| | Tensile Strength | (MPa) | 39 | 39 | 39 | 39 |
| | Elongation at Break | (%) | 410 | 410 | 410 | 410 |
| | Taper Abrasion | (mg) | 25 | 25 | 25 | 25 |
| | Appearance | (%) | 4 | 5 | 5 | 5 |

TABLE 3

| | | | Ex. 9 | Ex. 10 | Ex. 11 | Ex. 12 |
|---|---|---|---|---|---|---|
| Prepolymer | Polyisocyanate | Kind | MDI | MDI | MDI | MDI |
| Synthesis Step | Component | | | | | |
| | High Molecular | Kind | PTMEG | PTMEG | PTMEG | PTMEG |
| | Weight Polyol | Number Average | 800 | 800 | 1200 | 1200 |
| | | Molecular Weight | | | | |
| | Low Molecular | Kind | PTMEG | PTMEG | PTMEG | PTMEG |
| | Weight Polyol | Number Average | 250 | 250 | 250 | 250 |
| | | Molecular Weight | | | | |
| | Equivalent Ratio R1 | (NCO/OH) | 2.1 | 1.9 | 2.4 | 2.1 |
| | Content Ratio of | (mol/kg) | 1.63/0.69/0.10 | 1.73/0.60/0.30 | 1.44/0.50/0.10 | 1.57/0.43/0.30 |
| | Each Component to | | | | | |
| | Total Amount of | | | | | |
| | Polyisocyanate | | | | | |
| | Component, High | | | | | |
| | Molecular Weight | | | | | |
| | Polyol, and Low | | | | | |
| | Molecular Weight | | | | | |
| | Polyol | | | | | |
| | [Polyisocyanate | | | | | |
| | Component/High | | | | | |
| | Molecular Weight | | | | | |
| | Polyol/Low | | | | | |
| | Molecular Weight | | | | | |
| | Polyol] | | | | | |
| | Isocyanate Group | (% by mass) | 7.0 | 7.0 | 7.0 | 7.0 |
| | Concentration | | | | | |
| Chain Extension | Equivalent Ratio R2 | (NCO/OH) | 1.05 | 1.05 | 1.05 | 1.05 |
| Step | Urethanization | Kind | 0 | 0 | 0 | 0 |
| | Catalyst | Mixing Amount | 0 | 0 | 0 | 0 |
| | Chain Extender | Kind | 1,4-BD | 1,4-BD | 1,4-BD | 1,4-BD |
| Reaction | Initial Temperature | (° C.) | 110 | 110 | 110 | 110 |
| Conditions | Curing Temperature | (° C.) | 110 | 110 | 110 | 110 |
| | Holding Time | (hour) | 16 | 16 | 16 | 16 |
| Evaluation | A Hardness | — | 90 | 95 | 90 | 95 |
| | 100% Modulus | (MPa) | 9 | 10 | 8 | 9 |
| | 300% Modulus | (MPa) | 18 | 22 | 16 | 20 |
| | Tensile Strength | (MPa) | 43 | 45 | 38 | 41 |
| | Elongation at Break | (%) | 440 | 390 | 500 | 460 |
| | Taper Abrasion | (mg) | 20 | 25 | 20 | 25 |
| | Appearance | (%) | 4 | 4 | 4 | 4 |

TABLE 4

| | | | Ex. 13 | Ex. 14 |
|---|---|---|---|---|
| Prepolymer | Polyisocyanate | Kind | MDI | MDI |
| Synthesis Step | Component | | | |
| | High Molecular | Kind | PTMEG | PTMEG |
| | Weight Polyol | Number Average | 1000 | 1000 |
| | | Molecular Weight | | |
| | Low Molecular | Kind | PTMEG | PTMEG |
| | Weight Polyol | Number Average | 250 | 250 |
| | | Molecular Weight | | |
| | Equivalent Ratio R1 | (NCO/OH) | 1.9 | 2.2 |
| | Content Ratio of | (mol/kg) | 1.54/0.53/0.30 | 1.73/0.48/0.30 |
| | Each Component to | | | |
| | Total Amount of | | | |
| | Polyisocyanate | | | |
| | Component, High | | | |
| | Molecular Weight | | | |
| | Polyol, and Low | | | |
| | Molecular Weight | | | |
| | Polyol | | | |
| | [Polyisocyanate | | | |
| | Component/High | | | |
| | Molecular Weight | | | |
| | Polyol/Low | | | |
| | Molecular Weight | | | |
| | Polyol] | | | |
| | Isocyanate Group | (% by mass) | 6.0 | 8.0 |
| | Concentration | | | |
| Chain Extension | Equivalent Ratio R2 | (NCO/OH) | 1.05 | 1.05 |
| Step | Urethanization | Kind | 0 | 0 |
| | Catalyst | Mixing Amount | 0 | 0 |
| | Chain Extender | Kind | 1,4-BD | 1,4-BD |
| Reaction | Initial Temperature | (° C.) | 110 | 110 |
| Conditions | Curing Temperature | (° C.) | 110 | 110 |
| | Holding Time | (hour) | 16 | 16 |
| Evaluation | A Hardness | — | 93 | 97 |
| | 100% Modulus | (MPa) | 9 | 12 |
| | 300% Modulus | (MPa) | 20 | 23 |
| | Tensile Strength | (MPa) | 40 | 42 |
| | Elongation at Break | (%) | 450 | 390 |
| | Taper Abrasion | (mg) | 22 | 28 |
| | Appearance | (%) | 5 | 4 |

TABLE 5

| | | | Comparative Ex. | Comparative Ex. | Comparative Ex. | Comparative Ex. |
|---|---|---|---|---|---|---|
| | | | 1 | 2 | 3 | 4 |
| Prepolymer | Polyisocyanate | Kind | MDI | MDI | MDI | MDI |
| Synthesis Step | Component | | | | | |
| | High Molecular | Kind | PTMEG | PTMEG | PTMEG | PTMEG |
| | Weight Polyol | Number Average | 1000 | 1000 | 1000 | 1000 |
| | | Molecular Weight | | | | |
| | Low Molecular | Kind | PTMEG | PTMEG | PTMEG | PTMEG |
| | Weight Polyol | Number Average | 150 | 150 | 350 | 350 |
| | | Molecular Weight | | | | |
| | Equivalent Ratio R1 | (NCO/OH) | 2.2 | 2.0 | 2.2 | 2.1 |
| | Content Ratio of | (mol/kg) | 1.53/0.59/0.10 | 1.65/0.51/0.30 | 1.51/0/58/0.10 | 1.61/0.48/0.30 |
| | Each Component to | | | | | |
| | Total Amount of | | | | | |
| | Polyisocyanate | | | | | |
| | Component, High | | | | | |
| | Molecular Weight | | | | | |
| | Polyol, and Low | | | | | |
| | Molecular Weight | | | | | |
| | Polyol | | | | | |
| | [Polyisocyanate | | | | | |
| | Component/High | | | | | |
| | Molecular Weight | | | | | |
| | Polyol/Low | | | | | |
| | Molecular Weight | | | | | |
| | Polyol] | | | | | |
| | Isocyanate Group | (% by mass) | 7.0 | 7.0 | 7.0 | 7.0 |
| | Concentration | | | | | |
| Chain Extension | Equivalent Ratio R2 | (NCO/OH) | 1.05 | 1.05 | 1.05 | 1.05 |
| Step | Urethanization | Kind | — | — | — | — |
| | Catalyst | Mixing Amount | 0 | 0 | 0 | 0 |
| | Chain Extender | Kind | 1,4-BD | 1,4-BD | 1,4-BD | 1,4-BD |
| Reaction | Initial Temperature | (° C.) | 110 | 110 | 110 | 110 |
| Conditions | Curing Temperature | (° C.) | 110 | 110 | 110 | 110 |
| | Holding Time | (hour) | 16 | 16 | 16 | 16 |
| Evaluation | A Hardness | — | Prepolymer | Prepolymer | 80 | 85 |
| | 100% Modulus | (MPa) | Composition is | Composition is | 6 | 8 |
| | 300% Modulus | (MPa) | not melted at 80° | not melted at 80° | 13 | 16 |
| | Tensile Strength | (MPa) | C. | C. | 38 | 38 |
| | Elongation at Break | (%) | | | 520 | 480 |
| | Taper Abrasion | (mg) | | | 20 | 25 |
| | Appearance | (%) | | | 3 | 3 |

TABLE 6

| | | | Comparative Ex. | Comparative Ex. | Comparative Ex. | Comparative Ex. |
|---|---|---|---|---|---|---|
| | | | 5 | 6 | 7 | 8 |
| Prepolymer | Polyisocyanate | Kind | MDI | MDI | MDI | MDI |
| Synthesis Step | Component | | | | | |
| | High Molecular | Kind | PTMEG | PTMEG | PTMEG | PTMEG |
| | Weight Polyol | Number Average | 700 | 700 | 1300 | 1300 |
| | | Molecular Weight | | | | |
| | Low Molecular | Kind | PTMEG | PTMEG | PTMEG | PTMEG |
| | Weight Polyol | Number Average | 250 | 250 | 250 | 250 |
| | | Molecular Weight | | | | |
| | Equivalent Ratio R1 | (NCO/OH) | 2.0 | 1.9 | 2.5 | 2.2 |
| | Content Ratio of | (mol/kg) | 1.70/0.77/0.10 | 1.80/0.66/0.30 | 1.40/0.47/0.10 | 1.54/0.41/0.30 |
| | Each Component to | | | | | |
| | Total Amount of | | | | | |
| | Polyisocyanate | | | | | |
| | Component, High | | | | | |
| | Molecular Weight | | | | | |
| | Polyol, and Low | | | | | |
| | Molecular Weight | | | | | |
| | Polyol | | | | | |
| | [Polyisocyanate | | | | | |
| | Component/High | | | | | |
| | Molecular Weight | | | | | |
| | Polyol/Low | | | | | |
| | Molecular Weight | | | | | |
| | Polyol] | | | | | |
| | Isocyanate Group | (% by mass) | 7.0 | 7.0 | 7.0 | 7.0 |
| | Concentration | | | | | |
| Chain Extension | Equivalent Ratio R2 | (NCO/OH) | 1.05 | 1.05 | 1.05 | 1.05 |
| Step | Urethanization | Kind | — | — | — | — |
| | Catalyst | Mixing Amount | 0 | 0 | 0 | 0 |
| | Chain Extender | Kind | 1,4-BD | 1,4-BD | 1,4-BD | 1,4-BD |
| Reaction | Initial Temperature | (° C.) | 110 | 110 | 110 | 110 |
| Conditions | Curing Temperature | (° C.) | 110 | 110 | 110 | 110 |
| | Holding Time | (hour) | 16 | 16 | 16 | 16 |
| Evaluation | A Hardness | — | Prepolymer | Prepolymer | 87 | 92 |
| | 100% Modulus | (MPa) | Composition is | Composition is | 8 | 10 |
| | 300% Modulus | (MPa) | not melted at 80° | not melted at 80° | 16 | 22 |
| | Tensile Strength | (MPa) | C. | C. | 38 | 41 |
| | Elongation at Break | (%) | | | 500 | 470 |
| | Taper Abrasion | (mg) | | | 20 | 25 |
| | Appearance | (%) | | | 3 | 3 |

TABLE 7

| | | | Comparative Ex. | Comparative Ex. | Comparative Ex. | Comparative Ex. |
|---|---|---|---|---|---|---|
| | | | 9 | 10 | 11 | 12 |
| Prepolymer | Polyisocyanate | Kind | MDI | MDI | MDI | MDI |
| Synthesis Step | Component | | | | | |
| | High Molecular | Kind | PTMEG | PTMEG | PTMEG | PTMEG |
| | Weight Polyol | Number Average | 1000 | 1000 | 1000 | 1000 |
| | | Molecular Weight | | | | |
| | Low Molecular | Kind | PTMEG | PTMEG | PTMEG | PTMEG |
| | Weight Polyol | Number Average | 250 | 250 | 250 | 250 |
| | | Molecular Weight | | | | |
| | Equivalent Ratio R1 | (NCO/OH) | 1.7 | 2.4 | 2.3 | 2.0 |
| | Content Ratio of | (mol/kg) | 1.45/0.55/0.30 | 1.83/0.45/0.30 | 1.49/0.60/0.05 | 1.70/0.46/0.40 |
| | Each Component to | | | | | |
| | Total Amount of | | | | | |
| | Polyisocyanate | | | | | |
| | Component, High | | | | | |
| | Molecular Weight | | | | | |
| | Polyol, and Low | | | | | |
| | Molecular Weight | | | | | |
| | Polyol | | | | | |
| | [Polyisocyanate | | | | | |
| | Component/High | | | | | |
| | Molecular Weight | | | | | |
| | Polyol/Low | | | | | |
| | Molecular Weight | | | | | |
| | Polyol] | | | | | |
| | Isocyanate Group | (% by mass) | 5.0 | 9.0 | 7.0 | 7.0 |
| | Concentration | | | | | |
| Chain Extension | Equivalent Ratio R2 | (NCO/OH) | 1.05 | 1.05 | 1.05 | 1.05 |
| Step | Urethanization | Kind | — | — | — | — |
| | Catalyst | Mixing Amount | 0 | 0 | 0 | 0 |
| | Chain Extender | Kind | 1,4-BD | 1,4-BD | 1,4-BD | 1,4-BD |
| Reaction | Initial Temperature | (° C.) | 110 | 110 | 110 | 110 |
| Conditions | Curing Temperature | (° C.) | 110 | 110 | 110 | 110 |
| | Holding Time | (hour) | 16 | 16 | 16 | 16 |
| Evaluation | A Hardness | — | Prepolymer | 98 | 87 | Prepolymer |
| | 100% Modulus | (MPa) | Composition is | 13 | 8 | Composition is |
| | 300% Modulus | (MPa) | not melted at 80° | 25 | 15 | not melted at 80° |
| | Tensile Strength | (MPa) | C. | 45 | 35 | C. |
| | Elongation at Break | (%) | | 360 | 520 | |
| | Taper Abrasion | (mg) | | 40 | 20 | |
| | Appearance | (%) | | 2 | 3 | |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICATION

The polyurethane resin and the prepolymer composition of the present invention are preferably used in elastic molded articles, paints, coating agents, and adhesives.

1. A prepolymer composition comprising:
an isocyanate group-terminated prepolymer, wherein
the isocyanate group-terminated prepolymer contains a reaction product of a polyisocyanate component and a polyol component;
the polyisocyanate component contains a diphenylmethane diisocyanate;
the polyol component contains a high molecular weight polyol and a low molecular weight polyol;
the high molecular weight polyol contains a high molecular weight polyether polyol having a number average molecular weight of above 700 and below 1300;
the low molecular weight polyol contains a low molecular weight polyether polyol having the number average molecular weight of above 150 and below 350;
the isocyanate group concentration of the prepolymer composition is 6.0% by mass or more and 8.0% by mass or less; and
a content ratio of the low molecular weight polyol is above 0.05 mol/kg and below 0.40 mol/kg with respect to the total amount of the polyisocyanate component, the high molecular weight polyol, and the low molecular weight polyol.

2. A polyurethane resin comprising:
a reaction product of a prepolymer composition and a chain extender, wherein
the prepolymer composition contains an isocyanate group-terminated prepolymer;
the isocyanate group-terminated prepolymer contains a reaction product of a polyisocyanate component and a polyol component;
the polyisocyanate component contains a diphenylmethane diisocyanate;
the polyol component contains a high molecular weight polyol and a low molecular weight polyol;
the high molecular weight polyol contains a high molecular weight polyether polyol having a number average molecular weight of above 700 and below 1300;
the low molecular weight polyol contains a low molecular weight polyether polyol having the number average molecular weight of above 150 and below 350;
the isocyanate group concentration of the prepolymer composition is 6.0% by mass or more and 8.0% by mass or less; and
a content ratio of the low molecular weight polyol is above 0.05 mol/kg and below 0.40 mol/kg with respect to the total amount of the polyisocyanate component, the high molecular weight polyol, and the low molecular weight polyol.

3. An elastic molded article comprising the polyurethane resin according to claim 2.

4. A method for producing a prepolymer composition; the prepolymer composition containing an isocyanate group-terminated prepolymer, comprising:
a step of preparing a polyisocyanate component and a polyol component and
a step of reacting the polyisocyanate component with the polyol component to synthesize the isocyanate group-terminated prepolymer, wherein
the polyisocyanate component contains a diphenylmethane diisocyanate;
the polyol component contains a high molecular weight polyol and a low molecular weight polyol;
the high molecular weight polyol contains a high molecular weight polyether polyol having a number average molecular weight of above 700 and below 1300;
the low molecular weight polyol contains a low molecular weight polyether polyol having the number average molecular weight of above 150 and below 350;
the isocyanate group concentration of the prepolymer composition is 6.0% by mass or more and 8.0% by mass or less; and
a content ratio of the low molecular weight polyol is above 0.05 mol/kg and below 0.40 mol/kg with respect to the total amount of the polyisocyanate component, the high molecular weight polyol, and the low molecular weight polyol.
